(19) United States
(12) Patent Application Publication
(10) Pub. No.: US 2019/0226601 A1
(43) Pub. Date: Jul. 25, 2019

(54) VALVE CONTROLLER

(71) Applicant: IVEX Pty Ltd, Milperra NSW (AU)

(72) Inventors: Zhanzhao FENG, Sydney (AU); Jesse KOVAC, Sydney (AU)

(21) Appl. No.: 16/314,190

(22) PCT Filed: Jun. 28, 2017
(86) PCT No.: PCT/AU2017/050661

§ 371 Date: Dec. 28, 2018

(30) Foreign Application Priority Data
Jun. 30, 2016 (AU) 2016902583

(51) Int. Cl. F16K 31/48; F16K 37/00; F16K 31/04

(52) U.S. Cl. CPC F16K 31/48; F01N 1/166; F16K 31/04; F16K 37/0083

(57) ABSTRACT

A controller for controlling a valve is configured to record a time taken to drive the valve from a closed position to an open position, to determine a drive time required to drive the valve to a desired position based on the recorded time, and to drive the valve for the determined drive time.

### TECHNICAL FIELD

The invention described herein relates to a controller for controlling a valve. In particular, the invention is directed to a controller for controlling a muffler butterfly valve, although the scope of the invention may not necessarily be limited thereto.

### BACKGROUND ART

Due to the manufacturing cost and complexity, many of the existing butterfly valves, which are used on variable exhaust systems and mufflers are not equipped with position sensing and control mechanisms. Users therefore have no means of accurately determining the position of the valve and the degree to which the valve is open or closed, and thus no means to driving the valve to a specific desired position. This limits the functionality of variable exhaust systems, especially on the automatic controlled variable exhaust systems.

It is an aim of the invention to provide a controller and method for controlling a valve which overcomes or ameliorates one or more of the disadvantages or problems described above, or which at least provides the consumer with a useful choice.

### SUMMARY OF THE INVENTION

According to one aspect of the invention, there is provided a controller for controlling a valve, the controller being configured to

record a time taken to drive the valve from a closed position to an open position,

determine a drive time required to drive the valve to a desired position based on the recorded time, and

drive the valve for the determined drive time.

Advantageously, the controller is able to accurately control and drive the valve to a desired position as specified by the user.

The valve may be a butterfly valve of a muffler exhaust system.

The controller may control a drive motor for driving the valve. The controller may determine open and closed positions for the valve by detecting a surge in drive motor current when the valve has reached its open or closed end position. Typically, the drive motor will stall as the valve has reached an end position and can no longer move. The stalling of the drive motor creates a surge in the motor current, which is detectable by the controller to indicate that the valve has reached its open or closed position.

In another embodiment, position sensors may be used to indicate an end position of the valve. Accordingly, the controller may receive signals from position sensors to indicate a closed or open position has been reached by the valve. Any suitable position sensor may be used. For example, hall effect sensors may be used.

The controller is configured to drive the motor in a first direction to close the valve, and a second direction to open the valve.

Upon receipt of user instruction to drive the valve to a new position, the controller may determine a required travel time and drive direction for the drive motor to reach the new position.

More particularly, the controller may determine the required travel time (Tᵣ) based on the function below:

Tᵣ=(P_{new}−P_{current})×Tₘₐₓ

wherein,

P_{new} is the new position counter of the valve expressed as a fraction between 0 and 1, with 0 being the closed position and 1 being the open position (e.g. 0.5 would define a half open position for the valve);

P_{current} is the current position counter of the valve expressed as a fraction between 0 and 1, with 0 being the closed position (e.g. 0.5 would define a half open position for the valve);

Tₘₐₓ is the recorded time taken (measured in milliseconds) for the valve to move from the closed position to the open position.

If Tᵣ is a positive time value, the controller drives the valve in the second direction towards the open position, and if Tᵣ is a negative time valve, the controller drives the valve in the first direction towards the closed position. The absolute value of Tᵣ is the time period that the controller drives the motor.

The controller may record a new time taken to drive the valve from the closed position to the open position each time that the controller is turned on. In practice, the time taken to drive the valve from the closed position to the open position may vary over time due to environmental factors, such as friction, temperature, wear and tear of the valve assembly. Recording a new time taken to drive the valve from the closed position to the open position (Tₘₐₓ) each time that the controller is turned on reduces errors and inaccuracies which are developed over time.

In addition, each time that the valve is moved to the closed position, the controller may reset the current position counter (P_{current}) to 0. In this manner, the controller can advantageously eliminate accumulated errors in the valve position counter.

According to another aspect of the invention, there is provided a system for controlling a valve, the system including a drive motor for driving the valve, and a controller for controlling the drive motor, the controlling being as previously described.

The system may be a muffler control system for a vehicle, and the controller controls the valve of the muffler assembly.

According to a further aspect of the invention, there is provided a method for controlling a valve, the method including

recording a time taken to drive the valve from a closed position to an open position,

determining a drive time required to drive the valve to a desired position based on the recorded time, and

driving the valve for the determined drive time.

In order that the invention may be more readily understood and put into practice, one or more preferred embodiments thereof will now be described, by way of example only, with reference to the accompanying drawings.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristic described herein may be combined in any suitable manner in one or more combinations.

### BRIEF DESCRIPTION OF THE DRAWINGS

FIG. 1 is a schematic diagram of system for controlling a valve according to one embodiment of the invention.

FIG. 2 is a flow diagram illustrating a method for controlling a valve using the system of FIG. 1 according to an embodiment of the invention.

### DETAILED DESCRIPTION OF PREFERRED EMBODIMENT(S)

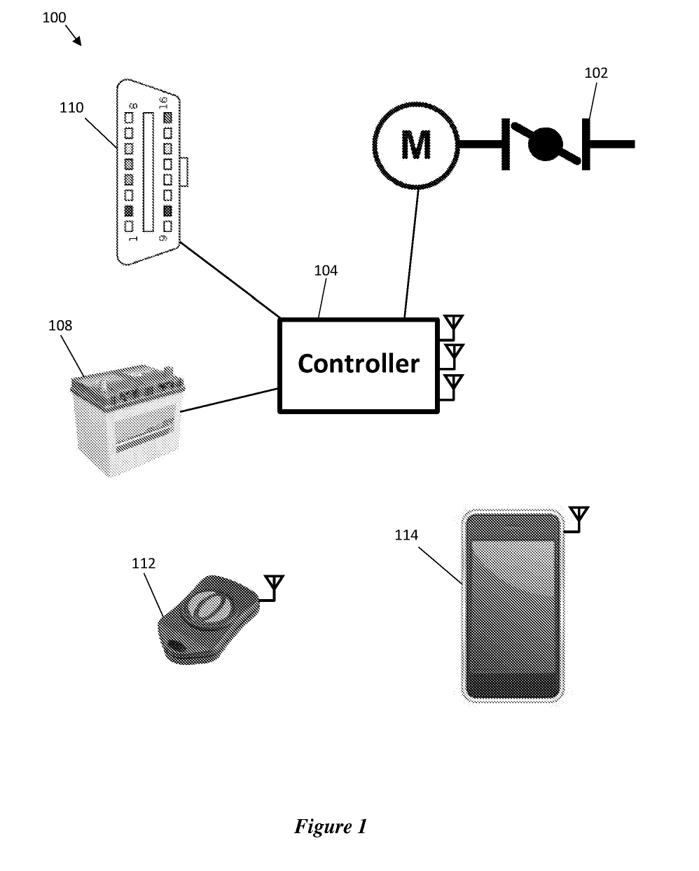

A control system 100 for a vehicle exhaust valve 102 is illustrated in FIG. 1. The system 100 includes a control circuit module (controller) 104 having a microcontroller for receiving and processing input signals and generating control signals to drive a drive motor 101 to move the valve 102 between open and closed positions. Executable control software commands embedded in the microcontroller and governing the manner in which the controller 104 processes input signals to drive the motor 101 will be discussed in further detail below.

The valve 102 is a butterfly valve associated with a vehicle muffler (not shown) and controls the flow of exhaust gases through the muffler. In a completely closed position, the valve 102 redirects flow of exhaust gases through a noise cancelling chamber of the muffler so as to provide maximum noise attenuation, which also generates maximum back pressure to the engine. In a completely open position, the valve 102 allows the gasses to bypass the noise cancelling chamber to provide minimum noise attenuation by the muffler, which also allows back pressure to the engine to be minimised. A DC motor (not shown) actuates movement of the valve 102.

The controller 104 can be powered by a power source 108 of the vehicle. In some embodiments, the power source 108 may be provided by a 12V DC auxiliary outlet, such as a cigarette lighter connector, of the vehicle. In some embodiments, the controller 104 may be hard wired via an accessory power or battery power cable of the vehicle.

The controller 104 generates control signals to drive the motor 101, which in turn drives the valve 102. The control signals can be generated based on operating parameters of the vehicle determined via communications port 110 of the vehicle. The microcontroller includes a vehicle interface for communication with port 110. In particular, the communications port 110 may be an On-board diagnostics port (e.g. OBD-II) of the vehicle. The controller 104 may be fitted with an OBD-II interpreter for compatibility with certain vehicles.

The system 100 further includes a remote control device 112 having manual buttons which can be used to move the valve 102 between its open and closed positions. For instance, the remote control device 112 may have an Open button and a Close button, upon activation of either button, the controller 104 generates a corresponding signal to move the valve 102 to an open or closed position. The remote control device 112 typically operates on a radio frequency of 433 MHz.

The system 100 further includes software control application installed on a mobile device 114. The mobile device 114 can communicate with the controller 104 wirelessly via WiFi and/or Bluetooth. When the remote control device 112 is used to change the valve 102 position, the position will be recorded by the controller 104 and synchronised to other interface devices, such as the mobile device 114. More than one mobile device 114 may be included in the system 100.

During configuration of the system 100, the controller 104 is set to drive the motor 101 in a first direction to close the valve 102, and in a second direction opposing the first direction to open the valve 102.

During operation of the system 100, the controller 104 receives control signals to move the valve 102 to a desired position. The control signals can be determined by the controller 104 based on operating parameters of the vehicle determined via communications port 110 of the vehicle, or received from the remote control device 112 or mobile device 114. The system 100 expresses valve positions by a fraction or a decimal number between 0 and 1, wherein 0 denotes a fully closed valve position and 1 denotes a fully open valve position. For example, a valve position (P) of:

0 denotes the fully closed position (i.e. 0% open valve position, the controller 104 drives the valve 102 until the closed end limit is detected in the form of a motor current surge.)

0.25 denotes a 25% open valve position,

0.5 denotes a 50% open valve position, and

0.75 denotes a 75% open valve position.

1 denotes a fully open valve positon (i.e. 100% open valve position, the controller 104 drives the valve 102 until the closed end limit is detected in the form of a motor current surge.)

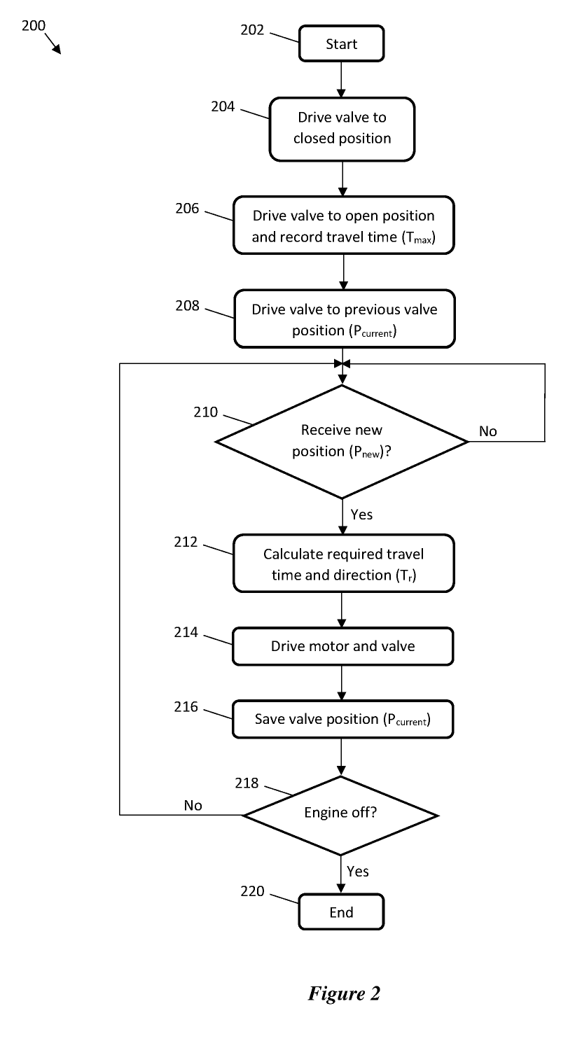

A method 200 of using the system 100 to drive the valve 102 to a desired position will now be explained with reference to FIG. 2.

At step 202, the driver turns on the vehicle engine and power is provided to turn on the controller 104. The controller 104 remembers the current position (P_{current}) of the valve 102 as the associated valve position counter is save in memory.

At step 204, the controller 104 immediately drives the valve 102 in the first direction towards the closed end position for the valve. Once the valve 102 reaches its closed position and can no longer move, the drive motor 101 will stall causing a surge in the motor current. For example, 1-2A of motor current may be used to drive the valve 102 between the open and closed positions, once the valve reaches the closed or open end position and stops moving, a surge motor current of roughly 6-8A can be detected by the controller 104. Once the surge motor current is detected, the valve 102 is in the closed position, and the controller 104 stops driving the motor 101.

At step 206, the controller 104 drives the valve 102 from the closed position in a second direction opposite the first direction, to the open position and records the total time taken (Tₘₐₓ) for the valve 102 to travel from the closed positon to the open position (e.g. in milliseconds). Typically, the value of Tₘₐₓ ranges between 250 ms to 350 ms. However, this can vary depending on the type of motor and valve used. As previously discussed, the controller 104 detects the open end position of the valve 102 when a surge in motor current caused by the stalling of the drive motor 101 is detected. In an alternative embodiment, positon sensors may be used to determine the closed and open positions of the valve 102.

At step 208, the controller 104 drives the motor 101 to return the valve 102 to the position of the valve immediately prior to turning on the motor (P_{current}) at step 202. The manner in which the controller 104 drives the motor 101 to achieve this will be explained further in relation to method steps 212 and 214 below.

At query step 210, if the controller 104 receives a control signal to move the valve 102 to a new position (P_{new}), the method 200 proceeds to step 212. If not, the method 200 returns to query step 210. The control signal can be determined by the controller 104 based on operating parameters of the vehicle determined via communications port 110 of the vehicle, or received from the remote control device 112 or mobile device 114.

At step 212, the controller 104 determines how the motor 101 must be driven to move the valve 102 as close as possible to the desired new position (P_{new}). Elaborating further, the controller 104 determines the required time Tᵣ and the drive direction for the motor 101 to move the valve 102 to new position (P_{new}). The controller 104 calculates Tᵣ based on the function below:

Tᵣ=(P_{new-}P_{current})×Tₘₐₓ

wherein,

P_{new} is the new position counter of the valve 102 expressed as a fraction between 0 and 1, with 0 being the closed position and 1 being the open position (e.g. 0.5 would define a half open position for the valve);

P_{current} is the current position counter of the valve 102 expressed as a fraction between 0 and 1, with 0 being the closed position (e.g. 0.5 would define a half open position for the valve);

Tᵣ is the recorded time taken (measured in milliseconds) for the valve 102 to move from the closed position to the open position.

If Tᵣ is a positive time value, the controller 104 drives the motor 101 in the first direction so that the valve 102 moves towards the open position, and if Tᵣ is a negative time valve, the controller 104 drives the motor 101 in a second direction so that the valve 102 moves towards the closed position. The absolute value of Tᵣ is the time period that the controller 104 drives the motor 101.

At step 214, the controller 104 drives the motor 101 based on the value of Tᵣ as calculated in step 212 as described above.

At step 216, once the valve 102 has moved the desired new position P_{new}, P_{new} is saved in memory as P_{current}.

At query step 218, if the driver turns off the engine, the method 200 proceeds to step 220. If not, the method 200 returns to query step 210.

One problem of using the formula in step 212 to calculate the required time to move the valve 102 to the desired new position is that, error is present at each instance that the valve 102 by the motor 101. This can be due to a number of factors including, heat, friction, inaccuracies of the motor and valve. For example, driving the motor 101 for 20 ms may move the valve 10° in one instance, but 10.3° in another instance. Over time, these errors can add up to be fairly significant.

To resolve this problem, the controller 104 records a new time taken to drive the valve 102 from the closed position to the open position each time that the controller is turned on (or the engine is turned on by the driver). This new recorded value for Tₘₐₓ overwrites the previous value for Tᵣ in memory. Recording a new time taken to drive the valve from the closed position to the open position (Tₘₐₓ) each time that the controller is turned on reduces errors and inaccuracies which are developed over time.

In addition, each time that the valve 102 is moved to the closed position, the controller reset the current position counter (P_{current}) to 0. In this manner, the controller can further eliminate accumulated errors in the valve position counter.

In an alternative embodiment, to increase accuracy of the system 100, the controller 104 at step 212 of the method 200 drives the motor 101 to return the valve 102 to its fully closed position, resets the valve position counter to 0 and drives the valve 102 to the new position. In this embodiment, once the valve 102 is returned to position ‘0’ or the fully closed position, the controller 104 determines the required time Tᵣ and the drive direction for the motor 101 to move the valve 102 to new position (P_{new}). The controller 104 calculates Tᵣ based on the function below:

Tᵣ=P_{new}×Tₘₐₓ

wherein,

P_{new} is the new position counter of the valve 102 expressed as a fraction between 0 and 1, with 0 being the closed position and 1 being the open position (e.g. 0.5 would define a half open position for the valve);

Tᵣ is the recorded time taken (measured in milliseconds) for the valve 102 to move from the closed position to the open position.

In a further embodiment, the controller 102 utilises a current time counter (T_{current}) to track the current position of the valve 102 and to determine the required time Tᵣ to move the valve 102 to the new position. In this embodiment, the controller 104 determines the required time Tᵣ and the drive direction for the motor 101 to move the valve 102 to new position (P_{new}). The controller 104 calculates Tᵣ based on the functions below:

T_{current}=P_{current}×Tₘₐₓ

Tᵣ=P_{new}×Tₘₐₓ−T_{current}

wherein,

P_{new} is the new position counter of the valve 102 expressed as a fraction between 0 and 1, with 0 being the closed position and 1 being the open position (e.g. 0.5 would define a half open position for the valve);

P_{current} is the current position counter of the valve 102 expressed as a fraction between 0 and 1, with 0 being the closed position (e.g. 0.5 would define a half open position for the valve);

Tᵣ is the recorded time taken (measured in milliseconds) for the valve 102 to move from the closed position to the open position.

T_{current} is the required time taken (measured in milliseconds) for the valve 102 to move from the closed position to the current position P_{current.}

If Tᵣ is a positive time value, the controller 104 drives the motor 101 in the first direction so that the valve 102 moves towards the open position, and if Tᵣ is a negative time valve, the controller 104 drives the motor 101 in a second direction so that the valve 102 moves towards the closed position. The absolute value of Tᵣ is the time period that the controller 104 drives the motor 101.

The above system and method provides a simple solution to control a valve, such as the butterfly valve of a vehicle exhaust system with suitable accuracy.

The system and method can also operate without the need for sensors. In vehicle exhaust systems, which are often subject to high temperatures, debris, high humidity, high acidity from the exhaust gases and weather conditions, electronic sensors may be unreliable. A system and method which can operate without sensors can operate more reliably.

The foregoing embodiments are illustrative only of the principles of the invention, and various modifications and changes will readily occur to those skilled in the art. The invention is capable of being practiced and carried out in various ways and in other embodiments. It is also to be understood that the terminology employed herein is for the purpose of description and should not be regarded as limiting.

The term “comprise” and variants of that term such as “comprises” or “comprising” are used herein to denote the inclusion of a stated integer or integers but not to exclude any other integer or any other integers, unless in the context or usage an exclusive interpretation of the term is required.

Reference to prior art disclosures in this specification is not an admission that the disclosures constitute common general knowledge.

1. A controller for controlling a valve, the controller being configured to
record a time taken to drive the valve from a closed position to an open position,
determine a drive time required to drive the valve to a desired position based on the recorded time, and
drive the valve for the determined drive time.

2. The controller as claimed in claim 1, wherein the valve is a butterfly valve of a muffler exhaust system.

3. The controller according to claim 1, wherein position sensors are used to indicate an end position of the valve.

4. The controller according to claim 1, wherein
the controller controls a drive motor for driving the valve, and
the controller determines open and closed positions for the valve by detecting a surge in drive motor current when the valve has reached its open or closed end position.

5. The controller according to claim 1, wherein upon receipt of user instruction to drive the valve to a new position, the controller determines a required travel time and drive direction for the drive motor to reach the new position.

6. The controller of claim 5, wherein the controller determines the required travel time (Tᵣ) based on the function below:
Tᵣ=(P_{new}−P_{current})×Tₘₐₓ
wherein,
P_{new} is a new position counter having a valve expressed as a fraction between 0 and 1, 0 defining a closed position, 1 defining an open position, and 0.5 defining a half open position for the valve;
P_{current} is a current position counter having a valve expressed as a fraction between 0 and 1, 0 defining the closed position, 1 defining the open position, and 0.5 defining the half open position for the valve;
Tₘₐₓ is a recorded time taken for the valve to move from the closed position to the open position.

7. The controller of claim 6, wherein
if Tᵣ is a negative time valve, the controller drives the valve in a first direction towards the closed position,
Tᵣ is a positive time value, the controller drives the valve in a second direction towards the open position, and
the absolute value of Tᵣ is a time period that the controller drives the motor.

8. The controller according to claim 1, wherein the controller records a new time taken to drive the valve from the closed position to the open position each time that the controller is turned on.

9. The controller according to claim 6, wherein each time that the valve is moved to the closed position, the controller resets the current position counter (P_{current}) to 0.

10. A system for controlling a valve, the system including
a drive motor for driving the valve, and
the controller according to claim 1.

11. A method for controlling a valve, the method including
recording a time taken to drive the valve from a closed position to an open position,
determining a drive time required to drive the valve to a desired position based on the recorded time, and
driving the valve for the determined drive time.
